(19) United States
(12) Patent Application Publication
(10) Pub. No.: US 2017/0164027 A1
(43) Pub. Date: Jun. 8, 2017

(54) VIDEO RECOMMENDATION METHOD AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Zhinan ZHANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,090

(22) Filed: Aug. 22, 2016

Related U.S. Application Data
(63) Continuation of application No. PCT/CN2016/089522, filed on Jul. 10, 2016.

(30) Foreign Application Priority Data
Dec. 3, 2015 (CN) 2015108827036X

(51) Int. Cl. H04N 21/25; H04N 21/84; G06F 17/30; H04N 21/435; H04N 21/466; H04N 21/278; H04N 21/235; H04N 21/434

(52) U.S. Cl. CPC H04N 21/25; H04N 21/235; H04N 21/84; H04N 21/4345; H04N 21/435; H04N 21/4668; H04N 21/278; G06F 17/3028; G06F 17/30256

(57) ABSTRACT

Embodiments of the present disclosure relate to communications field, and disclose a video recommendation method and an electronic device. The method includes: receiving a video cover image selection message sent by a terminal, where the video cover image selection message carries an identifier of a target video cover image selected by a user; extracting the identifier of the target video cover image from the video cover image selection message; acquiring at least one candidate video cover image matching the identifier of the target video cover image from an image database; and sending the at least one video cover image to the terminal.

### CROSS-REFERENCE TO RELATED APPLICATIONS

This application is a continuation of International Application No. PCT/CN2016/089522, with an international filing date of Jul. 10, 2016, which is based upon and claims priority to Chinese Patent Application No. 201510882703.6, filed on Dec. 3, 2015, the entire contents of all of which are incorporated herein by reference.

### TECHNICAL FIELD

Embodiments of the present disclosure relate to the communications field, and more particularly, to a video recommendation method and an electronic device.

### BACKGROUND

In the prior art, each video in a video APP page opened by a terminal (for example, a mobile phone, a computer, a tablet computer or the like) generally has a cover image, to provide a user with visual senses and some information about the video. In this way, the user may select whether to view the video according to the cover image. Therefore, a cover image plays an important role in video selection.

At present, a server generally recommends a video to a user by the text input by the user. For example, a video that meets a requirement is recommended to the user by a user's inputting or clicking categories, such as American dramas and action films. However, a video cannot be recommended according to image information. For example, if a cover image of a movie and television work is directly used to recommend a video similar to the movie and television work, a server cannot conveniently and rapidly recommend a video to the user by using a video image, therefore causing poor user experience.

### SUMMARY

With respect to the technical problem in the prior art that a video cannot be conveniently and rapidly recommended to a user according to a video image, embodiments of the present disclosure provide a video recommendation method. The method includes: receiving a video cover image selection message sent by a terminal, the video cover image selection message carrying an identifier of a target video cover image selected by a user; extracting the identifier of the target video cover image from the video cover image selection message; and acquiring at least one candidate video cover image matching the identifier of the target video cover image from an image database, and sending the at least one video cover image to the terminal, wherein the image database stores a video cover image, the video cover image having an identifier.

According to an embodiment of the present disclosure, there is provided with an electronic device. The electronic device includes: at least one processor; and a memory communicably connected with the at least one processor for storing instructions executable by the at least one processor, wherein execution of the instructions by the at least one processor causes the at least one processor to perform an above disclosed method.

According to an embodiment of the present disclosure, there is provided with another electronic device. The another electronic device includes: at least one processor and a memory communicably connected with the at least one processor for storing instructions executable by the at least one processor; wherein execution of the instructions by the at least one processor causes the at least one processor to: extract an identifier of a target video cover image from the target video cover image selected by a user; generate a video cover image selection message for the electronic apparatus to send the video cover image selection message to a server, the video cover image selection message carrying the identifier of the target video cover image; after the electronic apparatus receives at least one candidate video cover image sent by the server, display, on a screen, an identifier of the at least one video cover image matching the identifier of the target video cover image.

Other features and advantages of the present disclosure are described in detail in the specific embodiments hereinafter.

### BRIEF DESCRIPTION OF THE DRAWINGS

The accompanying drawings are used to provide a further understanding of the present disclosure, and constitute one part of the specification, which are used to explain the present disclosure in combination with the specific embodiments of the present disclosure, and this would not cause limitation to the present disclosure. In the accompanying drawings:

FIG. 1 is a schematic structural diagram that illustrates an exemplary video recommendation system according to an embodiment of the present disclosure;

FIG. 2 is an exemplary flowchart that illustrates a video recommendation method from a server side according to an embodiment of the present disclosure;

FIG. 3 is an exemplary flowchart that illustrates a video recommendation method at a terminal side according to an embodiment of the present disclosure; and,

FIG. 4 is a schematic hardware diagram of an electronic apparatus used for performing a video recommendation method according to an embodiment of the present disclosure.

### DETAILED DESCRIPTION

The specific embodiments of the present disclosure are described below in detail with reference to accompanying drawings. It should be understood that the specific embodiments described herein are merely used to describe and explain the present disclosure, and are not intended to limit the present disclosure.

A concept of the present disclosure is described hereinafter by using examples, but it should be understood that these examples are non-limiting examples, and the protection scope of the present disclosure is not limited thereto.

In order to more clearly describe the concept of the present disclosure, an interaction process between a terminal and a server that are used to execute the video recommendation method according to the present disclosure is described in detail.

FIG. 1 is a schematic structural diagram illustrating an exemplary video recommendation system according to an embodiment of the present disclosure (dashed-lines represent wireless communications between a server 100 and a terminal 200). As illustrated in FIG. 1, the system may include: a server 100 and a terminal 200. The server 100 further includes: a first receiving module 10, configured to receive a video cover image selection message sent by the terminal 200, wherein the video cover image selection message carries an identifier of a target video cover image selected by a user; a first identifier extracting module 11, configured to extract the identifier of the target video cover image from the video cover image selection message; an acquiring module 12, configured to acquire at least one candidate video cover image matching the identifier of the target video cover image from an image database; a first sending module 13, configured to send the at least one video cover image to the terminal; and an image database 14, configured to store a video cover image, wherein the video cover image has an identifier. The video cover image has more than two identifiers.

Correspondingly, the terminal 200 may further include: a second identifier extracting module 20, configured to extract an identifier of a target video cover image from the target video cover image selected by a user; a message generating module 21, configured to generate a video cover image selection message, wherein the video cover image selection message carries the identifier of the target video cover image; a second sending module 22, configured to send the video cover image selection message to a server; a second receiving module 23, configured to receive at least one candidate video cover image sent by the server; and a displaying module 24, configured to display the candidate video cover image, wherein an identifier of the at least one video cover image matches the identifier of the target video cover image. The terminal may further include: a video acquiring module, configured to acquire, according to a video cover image of interest selected by the user from the candidate video cover image, a video corresponding to the video cover image of interest. The displaying module 24 may further extract the identifier of the candidate video cover image, and display, based on classification, the at least one video cover image according to the identifier of the candidate video cover image.

Specifically, to implement video recommendation based on an image, the server 100 may preset the image database 14, the image database 14 may store the video cover image, and the video cover image has the identifier. For example, the video cover image has more than two identifiers. For example, the image database 14 may include any quantity of the video cover images, and an identifier corresponding to each video cover image in the any quantity of the video cover images, and each video cover image may have more than two identifiers. For example, the image database may further include video data related to the video cover images except the above data. With the implementation manner, after the user selects a video cover image corresponding to a video, the server 100 may search another video cover image having a matching identifier for a user in the established image database 14, to implement video recommendation based on an image.

In the video recommendation system, a specific interaction process between the terminal 200 and the server 100 is described as what follows:

First, the user may select, by using the terminal 200 (for example, a mobile phone, a computer, and a tablet computer), for example, one video cover image as a target video cover image in the image database 14 provided by the server 100. Then the second identifier extracting module 20 of the terminal 200 may extract the identifier of the target video cover image from the target video cover image selected by the user. For example, a video may correspond to one or more identifiers. For example, a video “Iron man” may correspond to multiple identifiers, such as “American”, “Science fiction”, and “Action”. The identifier and extraction of the identifier may be practiced in any proper form in the prior art, and to not to obscure the protection scope of the present invention, details are not given herein. The message generating module 21 may generate the video cover image selection message, wherein the video cover image selection message carries the identifier of the target video cover image. Then the second sending module 22 sends the video cover image selection message to the server 100.

Subsequently, the first receiving module 10 of the server 100 may receive the video cover image selection message sent by the terminal 200, wherein the video cover image selection message carries the identifier of the target video cover image selected by the user. The first identifier extracting module 11 of the server 100 may extract the identifier of the target video cover image from the video cover image selection message. The acquiring module 12 of the server 100 may acquire the at least one video cover image (for example, acquire any quantity of the candidate video cover images) matching the identifier of the target video cover image from the image database 14, for example, acquire at least one candidate video cover image (for example, “The avengers”, “Superman”, and “Captain America”) having identifiers, such as “American” and/or “Science fiction” and/or “action”, and the first sending module 13 of the server 100 may send the at least one video cover image to the terminal 200.

Correspondingly, the second receiving module 23 of the terminal 200 may receive the at least one video cover image sent by the server 100. The displaying module 24 may display the candidate video cover image, where the identifier of the at least one video cover image matches the identifier of the target video cover image.

For example, the displaying module 24 may further extract the identifier of the candidate video cover image, and display, based on classification, the at least one video cover image according to the identifier of the candidate video cover image. The terminal 200 may further include: a video acquiring module, where the video acquiring module may acquire, according to a video cover image of interest selected by the user from the candidate video cover image, a video corresponding to the video cover image of interest. For example, the user may select a video cover image of “The avengers” from the candidate video cover images, for example, “The avengers”, “Superman”, and “Captain America”, acquire a video corresponding to the video cover image of interest, and execute a playback operation, such that the user may view the video in the terminal.

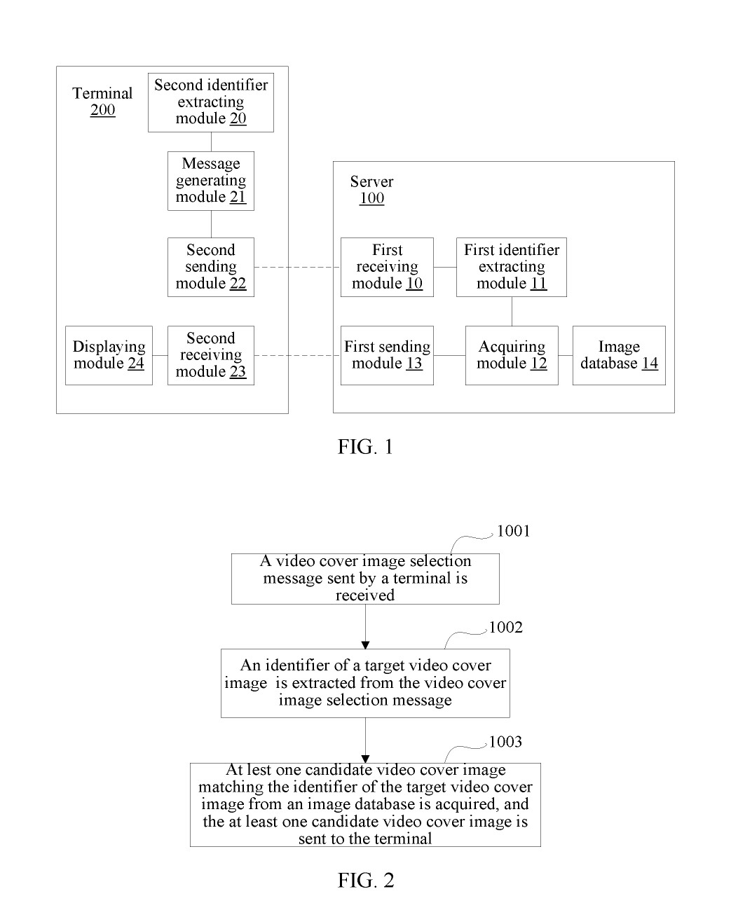

FIG. 2 is an exemplary flowchart illustrating a video recommendation method at a server side according to an embodiment of the present disclosure. As illustrated in FIG. 2, the method may include the following steps:

In Step 1001, the server receives a video cover image selection message sent by a terminal, where the video cover image selection message carries an identifier of a target video cover image selected by a user.

In Step 1002, the server extracts the identifier of the target video cover image from the video cover image selection message.

In Step 1003, the server acquires at least one candidate video cover image matching the identifier of the target video cover image from an image database, and sends the at least one video cover image to the terminal, where the image database stores a video cover image, and the video cover image has an identifier.

For example, the video cover image has more than two identifiers.

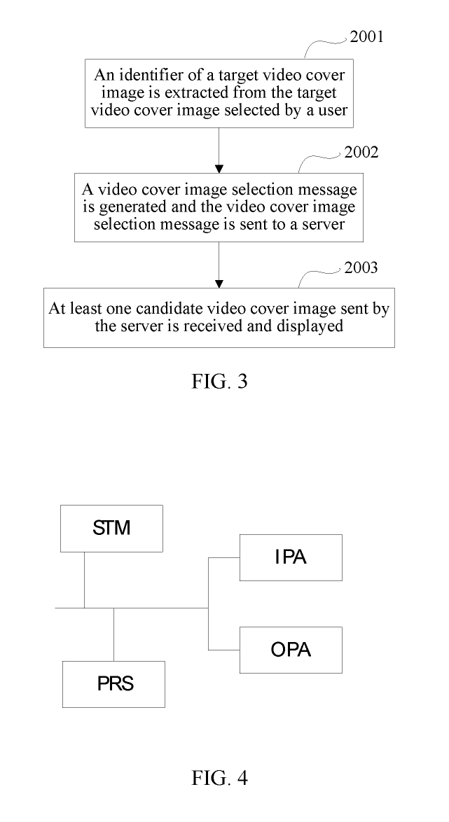

FIG. 3 is an exemplary flowchart illustrating a video recommendation method at a terminal side according to an embodiment of the present disclosure. As illustrated in FIG. 3, the method may include the following steps:

In Step 2001: the terminal extracts an identifier of a target video cover image from the target video cover image selected by a user.

In Step 2002: the terminal generates a video cover image selection message and sends the video cover image selection message to a server, where the video cover image selection message carries the identifier of the target video cover image.

In Step 2003: the terminal receives and displays at least one candidate video cover image sent by the server, where an identifier of the at least one video cover image matches the identifier of the target video cover image.

For example, the method further includes: acquiring, according to a video cover image of interest selected by the user from the candidate video cover image, a video corresponding to the video cover image of interest.

For example, the receiving and displaying at least one candidate video cover image sent by the server includes: extracting the identifier of the candidate video cover image; and classifying and displaying the at least one video cover image according to the identifier of the candidate video cover image.

It should be understood that, embodiments of the video recommendation method are already described in detail in the embodiments of the exemplary video recommendation system (as described above), which are thus not described herein any further. In addition, a person skilled in the art may select any one of the embodiments according to the present disclosure, or any combination of the embodiments to configure a terminal and/or a server, and alternative embodiments also falls within the protection scope of the present disclosure.

With the video recommendation method, system, the terminal, and the server provided in the embodiments of the present disclosure, a video can be conveniently and rapidly recommended to a user according to a video cover image. For example, other videos similar to a movie and television work are recommended to the user according to a cover image of the movie and television work, such that a larger selection scope is accessible to the user, and user experience is improved.

According to an embodiment of the present disclosure, there is provided with a non-transitory computer-readable storage medium storing executable instructions that, when executed by an electronic apparatus, cause the electronic apparatus to perform any one of above disclosed methods.

FIG. 6 illustrates a schematic hardware diagram of an electronic device for performing any one of above disclosed methods. According to FIG. 6, the electronic device includes one or more processors PRS and a storage medium STM. FIG. 6 shows one processor PRS as an example.

The electronic device can further include an input apparatus IPA and an output apparatus OPA.

The one or more processors PRS, storage medium STM and output apparatus OPA may be connected by a bus or other means. FIG. 6 shows a bus as an example for connection.

Storage medium STM is a non-transitory computer-readable medium for storing a non-transitory software program, a non-transitory computer-readable program and module, for example the program instructions/module for performing an above described method (e.g. second identifier extracting module 20, message generating module 21, and first identifier extracting module 11 and acquiring module 12 shown in FIG. 1). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but is not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic device of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player (e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which modules/units that are described above as separate elements may be physically separate or not separate modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Although the embodiments of the present disclosure have been described in detail above with reference to the accompanying drawings, the embodiments of the present disclosure are not limited to specific details in the above embodiments. Various simple variations can be made to the technical solutions of the present disclosure within the scope of the technical concept of the present disclosure, and such simple variations shall all fall within the protection scope of the present disclosure.

It should be further noted that the specific technical features described in the above specific embodiment can be combined in any appropriate manner as long as no conflict occurs. To avoid unnecessary redundancies, various possible combination manners will not be described in the present disclosure.

In addition, various different embodiments of the present disclosure may also be combined arbitrarily. Such combinations shall also be considered as the content disclosed by the present disclosure as long as these combinations do not depart from the concept of the present disclosure.

What is claimed is:

1. A video recommendation method, comprising:
at a server;
receiving a video cover image selection message sent by a terminal, wherein the video cover image selection message carries an identifier of a target video cover image selected by a user;
extracting the identifier of the target video cover image from the video cover image selection message; and
acquiring at least one candidate video cover image matching the identifier of the target video cover image from an image database, and sending the at least one candidate video cover image to the terminal;
wherein the image database stores a video cover image, wherein the video cover image has an identifier.

2. The method according to claim 1, wherein the video cover image has two or more identifiers.

3. An electronic device, comprising:
at least one processor and a memory communicably connected with the at least one processor for storing instructions executable by the at least one processor;
wherein execution of the instructions by the at least one processor causes the at least one processor to:
receive a video cover image selection message sent by a terminal, the video cover image selection message carrying an identifier of a target video cover image selected by a user;
extract the identifier of the target video cover image from the video cover image selection message;
acquire at least one candidate video cover image matching the identifier of the target video cover image from an image database;
send the at least one candidate video cover image to the terminal; and
store a video cover image, the video cover image having an identifier.

4. The electronic device according to claim 3, wherein the video cover image has more than two identifiers.

5. An electronic device, comprising:
at least one processor and a memory communicably connected with the at least one processor for storing instructions executable by the at least one processor;
wherein execution of the instructions by the at least one processor causes the at least one processor to:
extract an identifier of a target video cover image from the target video cover image selected by a user;
generate a video cover image selection message for the electronic apparatus to send the video cover image selection message to a server, the video cover image selection message carrying the identifier of the target video cover image;
after the electronic apparatus receives at least one candidate video cover image sent by the server, display, on a screen, an identifier of the at least one video cover image matching the identifier of the target video cover image.

6. The electronic device according to claim 5, wherein the at least one processor is further caused to:
acquire, according to a video cover image of interest selected by a user from the at least one candidate video cover image, a video corresponding to the video cover image of interest.

7. The electronic device according to claim 5, wherein to receive and display at least one candidate video cover image sent by the server the at least one processor is further caused to:
extract the identifier of the at least one candidate video cover image; and
classify the at least one candidate video cover image for screen display according to the identifier of the candidate video cover image.

8. A non-transitory computer-readable storage medium storing executable instructions that, when executed by an electronic device, cause the electronic device to:
receive a video cover image selection message sent by a terminal, wherein the video cover image selection message carries an identifier of a target video cover image selected by a user;
extract the identifier of the target video cover image from the video cover image selection message; and
acquire at least one candidate video cover image matching the identifier of the target video cover image from an image database, and sending the at least one candidate video cover image to the terminal;
wherein the image database stores a video cover image, wherein the video cover image has an identifier.

9. The storage medium of claim 8, wherein the video cover image has two or more identifiers.
